(19) United States
(12) Patent Application Publication
(10) Pub. No.: US 2025/0388027 A1
(43) Pub. Date: Dec. 25, 2025

(54) PRINTER FOR IDENTIFYING A TYPE OF THERMAL PRINTHEAD (TPH) AND A METHOD THEREOF

(71) Applicant: Hand Held Products, Inc., Charlotte, NC (US)

(72) Inventors: Noorasykin Mokhtar, Singapore (SG); Harry Nicholas Lansangan, Singapore (SG); Hao Zheng, Singapore (SG)

(21) Appl. No.: 18/752,204

(22) Filed: Jun. 24, 2024

(51) Int. Cl. B41J 2/355; B41J 2/335; B41J 2/345; B41J 2/505

(52) U.S. Cl. CPC B41J 2/355; B41J 2/3352; B41J 2/345; B41J 2/5056

(57) ABSTRACT

A printer for identifying a type of thermal printhead (TPH) is provided. The printer comprising at least one TPH comprising a plurality of dots. Each dot has an associated resistance. The plurality of dots are in a first pattern having a first end and a second end. The printer may determine a resistance value for each dot. The printer compares the resistance value(s) associated with at least one dot of the first end and at least one dot of the second end with a predefined threshold resistance value. The printer identifies at least one dot having a high resistance value and identify a type of TPH based at least on the at least one heating dot identified.

### TECHNOLOGICAL FIELD

Example embodiments of the present disclosure relate generally to a printing apparatus, and more specifically relates to identifying a type of thermal printhead (TPH) of a printer.

### BACKGROUND

In various printing applications, a thermal printhead (TPH) offers a reliable and efficient method for producing a high-quality print on various media types. The TPH is used in various industries, such as in retail, logistics, healthcare, and manufacturing. The TPH utilizes a principle of resistance heating that selectively heats specific areas of thermal sensitive media to produce texts, graphics, barcodes, or images. A conventional TPH consists of an array of tiny resistive heating elements. Each heating element is configured to achieve precise modulation of a heat output. The heat output of different TPH's differs from one another. Identification of the TPH is necessary to select a correct operation to prevent damage to the media and ensure durability and efficiency of the TPH.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

The following presents a summary of some example embodiments to provide a basic understanding of some aspects of the present disclosure. This summary is not an extensive overview and is intended to neither identify key or critical elements nor delineate the scope of such elements. It will also be appreciated that the scope of the disclosure encompasses many potential embodiments in addition to those here summarized, some of which will be further described in the detailed description that is presented later.

In an example embodiment a printer is disclosed. The printer comprising at least one thermal printhead (TPH) comprising a plurality of dots. Each dot has an associated resistance. Further, the plurality of dots are arranged in a first pattern. Further, the first pattern includes a first end and a second end. Further, a processor and a non-transitory memory comprising a computer program code, the non-transitory memory and the computer program code configured to, with the processor, cause the printer to determine a resistance value for each dot of the plurality of dots; compare the resistance value associated with at least one dot associated with the first end and at least one dot associated with the second end with a predefined threshold resistance value; identify at least one dot having a high resistance value based at least on the comparison; and identify a type of TPH of the at least one TPH based at least on the at least one heating dot identified.

In some embodiments, the non-transitory memory and the computer program code are configured to, with the processor, cause the printer to determine a thermal management technique based at least on the type of TPH of the at least one TPH identified. In some embodiments, the at least one TPH further comprising a plurality of heaters. Each of the plurality of heaters is associated with one dot of the plurality of dots. In some embodiments, the non-transitory memory and the computer program code are configured to, with the processor, cause the printer to adjust a thermal output of the plurality of heaters based at least on the determined thermal management technique.

In some embodiments, the plurality of dots correspond to a plurality of shift registers associated with the at least one TPH. In some embodiments, the predefined threshold resistance value associated with the plurality of dots is stored in the non-transitory memory. In some embodiments, the non-transitory memory and the computer program code are configured to, with the processor, cause the printer to read the resistance value of each of the plurality of dots during a booting phase of the printer.

In some embodiments, the resistance value of each dot defines a range of TPH resistance specification (for example, 900 ohms)+/−certain manufacturing tolerance (for example, 7%). In some embodiments, the plurality of dots define a range between 0-N dots. In some embodiments, the type of TPH of the at least one TPH identified is one of a plurality of TPH series. In some embodiments, the first pattern of the plurality of dots corresponds to a resistance pattern of the plurality of dots. Further, the resistance pattern defines the type of TPH of the at least one TPH.

In another example embodiment, a method is disclosed. The method comprises steps for determining a resistance value for each dot of a plurality of dots of at least one TPH. Further, the plurality of dots are arranged in a first pattern where the first pattern includes a first end and a second end. The method further comprises steps of comparing the resistance value associated with at least one dot associated with the first end and at least one dot associated with the second end with a predefined threshold resistance value. Further, the method comprises steps of identifying at least one dot having a high resistance value based at least on the comparison and identifying a type of TPH of the at least one TPH, based at least on the at least one heating dot identified.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a block diagram of a printer in accordance with an example embodiment of the present disclosure;

FIG. 2 illustrates a flowchart of a method for identifying at least one TPH in accordance with an example embodiment of the present disclosure;

FIGS. 3A and 3B illustrate a schematic diagram of an integrated circuit (IC) associated with the at least one TPH, in accordance with an example embodiment of the present disclosure.

FIG. 4 illustrates a graph associated with a predefined threshold resistance value of a plurality of dots in accordance with an example embodiment of the present disclosure;

FIG. 5A illustrates a graph associated with the resistance values associated with the plurality of dots of a first type of TPH of the at least one TPH in accordance with an example embodiment of the present disclosure;

FIG. 5B illustrates a graph associated with the resistance values associated with the plurality of dots of a second type of TPH of the at least one TPH in accordance with an example embodiment of the present disclosure;

FIG. 5C illustrates a graph associated with the resistance values associated with the plurality of dots of a third type of TPH of the at least one TPH in accordance with an example embodiment of the present disclosure; and

FIG. 6 illustrates a flowchart of a method for identifying a type of the at least one TPH in accordance with an example embodiment of the present disclosure.

### DETAILED DESCRIPTION

Some embodiments will now be described more fully hereinafter with reference to the accompanying drawings, in which some, but not all, embodiments of the present disclosure arc shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the present disclosure described herein such that embodiments may include fewer or more components than those shown in the figures while not departing from the scope of the present disclosure. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

The present disclosure provides embodiments of a printer and method for identifying a type of at least one thermal printhead (TPH). Embodiments of the printer comprise at least one of a plurality of different TPHs. Embodiments of the TPH may comprise a plurality of dots where each dot has an associated resistance value and the TPH. The plurality of dots are arranged in a first pattern, where the first pattern includes a first end and a second end. Embodiments may be configured to determine a resistance value for each dot of the plurality of dots by using a processor and a non-transitory memory comprising a computer program code. Embodiments may be configured to compare the resistance value associated with at least one dot associated with the first end and at least one dot associated with the second end with a predefined threshold resistance value, by using the processor and the non-transitory memory. Embodiments may be configured to identify at least one dot having a high resistance value based at least on the comparison, by using the processor and the non-transitory memory. Embodiments may be configured to identify a type of TPH of the plurality of different TPHs based at least on the at least one dot identified, by using the processor and the non-transitory memory.

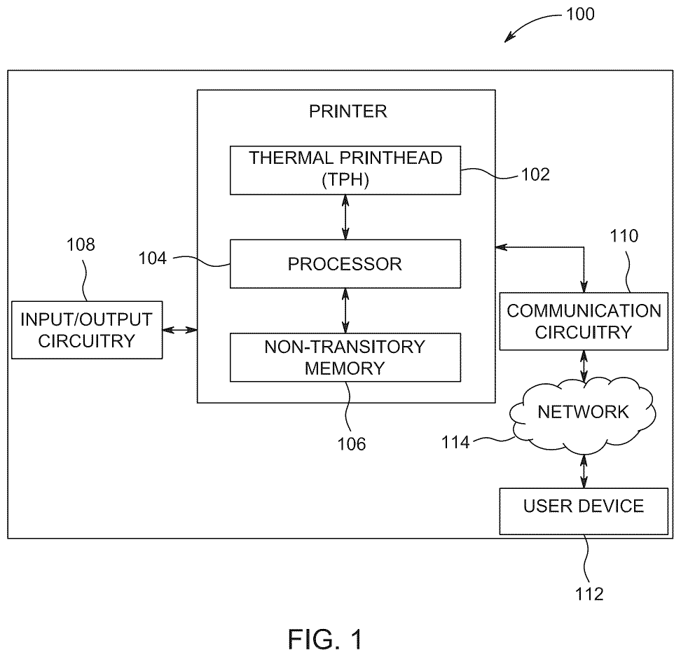

FIG. 1 illustrates a block diagram of a printer 100, in accordance with an example embodiment of the present disclosure. The printer 100 comprises at least one thermal printhead (TPH) 102, a processor 104, and a non-transitory memory 106. The printer 100 further comprises an input/output circuitry 108 and a communication circuitry 110.

In some embodiments, the printer 100 may be configured to print one or more pages. In at least one example, the printer 100 may be configured to print one or more labels. In various other examples, the printer 100 may be configured to print one or more tags in real time. In some embodiments, the printer 100 may comprise a printer assembly (not shown). Further, the printer assembly may be configured to perform a printing operation for the printer 100. In some embodiments, the printing assembly of the printer 100 comprises one or more paper rolls (not shown), at least one ink cartridge (not shown), the at least one TPH 102, and one or more motorized actuators (not shown). In some embodiments, the printer 100 may be communicatively coupled with a user device 112 through the input/output circuitry 108 or the communication circuitry 110. In some embodiments, upon receiving a print command from the user device 112, the one or more motorized actuators provide an omnidirectional movement to the at least one TPH 102 while performing the printing operation.

In some embodiments, the at least one TPH 102 may be configured to perform printing operation by using resistive heating. In some embodiments, the at least one TPH 102 may further comprise a plurality of dots (not shown). Further, in various embodiments, the plurality of dots define a range between 0-N dots. Various embodiments may include more or less dots. Further, each of the plurality of dots may have an associated resistance. In some embodiments, the plurality of dots of the at least one TPH 102 may be arranged in a first pattern. Further, the first pattern of the plurality of dots may comprise a first end and a second end. In some embodiments, the plurality of dots at the first end of the first pattern may have a resistance value different from the plurality of dots at the second end of the first pattern.

Further, the at least one TPH 102 comprises a plurality of heaters. In some embodiments, each heater of the plurality of heaters may be associated with one dot of the plurality of dots. In some embodiments, the plurality of heaters may be manufactured with a resistive material that is configured to generate a pre-defined amount of heat when supplied with a pre-defined voltage. In some embodiments, the material of the plurality of heaters may comprise at least one of nichrome, tantalum nitride, or platinum. In some embodiments, the material of the plurality of heaters of the at least one TPH 102 may be selected in a view of having an efficient thermal conductivity.

In some embodiments, the plurality of heaters of the at least one TPH 102 may be applied with a pre-defined amount of voltage to generate heat. Further, when the pre-defined amount of voltage is applied to the plurality of heaters of the at least one TPH 102, then the plurality of heaters may be configured to generate heat due to resistance of the material. Further, due to heating of the plurality of heaters, the at least one TPH 102 forms one or more patterns on a thermally sensitive media. Further, the thermally sensitive media may comprise at least one of a thermal paper or labels.

In an example, the plurality of heaters may be arranged in a grid pattern having one or more rows and one or more columns of the plurality of heaters to cover a desired printing area. In some embodiments, upon actuation of specific heaters of the plurality of heaters, one or more desired patterns, texts, graphics, or barcodes may be printed by the at least one TPH 102. In at least one example, the at least one TPH 102 may be designed such that the plurality of dots may have different resistance values. Further, the resistance values associated with each dot of the plurality of dots may be configured to provide a pattern of resistance values. Further, the pattern of resistance values is configured to define identification of the at least one TPH 102.

In some embodiments, the printer 100 further comprises the processor 104. Further, the processor 104 is communicatively coupled with the at least one TPH 102. In some embodiments, the processor 104 may include suitable logic, circuitry, and/or interfaces that are operable to execute one or more instructions stored in the non-transitory memory 106 to perform predetermined operations. In one embodiment, the processor 104 may be configured to decode and execute any instructions received from one or more other electronic devices or server(s). The processor 104 may be configured to execute one or more computer-readable program instructions, such as program instructions to carry out any of the functions described in this description. Further, the processor 104 may be implemented using one or more processor technologies known in the art. Examples of the processor 104 include, but are not limited to, one or more general purpose processors and/or one or more special purpose processors.

Further, the non-transitory memory 106 is communicatively coupled to the processor 104. Further, the non-transitory memory 106 may comprise a computer program code. Further, the computer program code of the non-transitory memory 106 may further comprise a set of instructions and data that are executed by the processor 104. Further, the non-transitory memory 106 may include the one or more instructions that are executable by the processor 104 to perform specific operations. It is apparent to a skilled artisan that the one or more instructions stored in the non-transitory memory 106 enable the hardware of the printer 100 to perform the predetermined operations.

Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

In some embodiments, the non-transitory memory 106 and the computer program code configured to, with the processor 104 may cause the printer 100 to determine a resistance value of each dot of the plurality of dots during a booting phase of the printer 100. Further, the resistance value of each dot of the plurality of dots defines a range of TPH resistance specification (for example, 900 ohms)+/−certain manufacturing tolerance (for example, 7%). It may be noted that for different TPH model, the range of TPH resistance may be different.

Further, upon determining the resistance value of each dot, the non-transitory memory 106 and the computer program code with the processor 104 may cause the printer 100 to compare the resistance value of at least one dot associated with the first end of the first pattern and/or at least one dot associated with the second end of the first pattern with a predefined threshold resistance value. Further, the non-transitory memory 106 may be configured to store the predefined threshold resistance value associated with the plurality of dots. In some embodiments, the non-transitory memory 106 and the computer program code configured to, with the processor 104 may cause the printer 100 to identify at least one dot from the plurality of dots having a high resistance value, based at least on the comparison.

Further, upon identifying the at least one dot, the non-transitory memory 106 and the computer program code configured to, with the processor 104 may cause the printer 100 to identify a type of TPH of the at least one TPH 102, based on the at least one heating dot. In some embodiments, the type of the at least one TPH identified may correspond to one of a plurality of TPH series.

In an example, the at least one TPH 102 may comprise 800 dots. Further, a first pattern of the plurality of dots may be designed such that the 10^{th} dot from the first end of the first pattern and the 750^{th} dot from the second send of the first pattern may have a resistance value of 900 ohms. Further, the processor 104 with the non-transitory memory 106 may be configured to cause the printer 100 to determine the resistance value of each dot from the 800 dots. Further, the processor 104 with the non-transitory memory 106 may be configured to compare the resistance value associated with 10^{th} and 750^{th} dot with a predefined threshold resistance value associated with the 800 dots. Further, the processor 104 with the non-transitory memory 106 may be configured to identify the 10^{th} dot and the 750^{th} dot having a resistance value of 900 ohms, based at least one the comparison. Further, the processor 104 with the non-transitory memory 106 may be configured to identify a type of TPH of the at least one TPH 102, for the identified 10^{th} dot and the 750^{th} dot.

In some embodiments, the non-transitory memory 106 and the computer program code configured with the processor 104 may cause the printer 100 to determine a thermal management technique based on the type of the at least one TPH 102. Further, the thermal management technique may correspond to monitoring of one or more parameters associated with each of the plurality of heaters. Further, the one or more parameters may comprise temperature, power consumption, and printing speed. In some embodiments, by using the determined thermal management technique, the non-transitory memory 106 and the computer program code with the processor 104 may cause the printer 100 to dynamically adjust a thermal output of the plurality of heaters. Further, based on an adjusted temperature reading and desired printing speed, the thermal management technique may be configured to alter or adjust power supplied to the plurality of heaters to ensure efficient printing operation by the printer 100.

As illustrated in FIG. 1, the printer 100 may comprise the input/output circuity that enables the user to communicate or interact with the printer 100 via the user device 112. It may be noted that the input/output circuitry 108 may act as a medium to transmit input from the user device 112 to and from the printer 100. In some embodiments, the input/output circuitry 108 may refer to the hardware and software components that facilitate the exchange of information between the user and the printer 100. The input/output circuitry 108 may include various input devices such as keyboards, barcode scanners, GUI for the user to provide data and various output devices such as displays, printer 100s for the user to receive data.

In one example, the user device 112 may include N number of user devices. In some embodiments, the user device 112 may include a graphical user interface (GUI) configured to allow the user to input data. In some embodiments, the user device 112 may comprise one or more mobile phones, laptops, or like. In some embodiments, the communication circuitry 110 may allow the printer 100 and the user device 112 to exchange data or information with other systems or apparatuses. Further, the printer 100 may be communicatively coupled with a network 114 via one or more protocols and software modules for sending and receiving data or information. In some embodiments, the communication circuitry 110 may include Ethernet ports, Wi-Fi adapters, or communication protocols for connecting with other systems. The communication circuitry 110 may allow the printer 100 to stay up-to-date.

It will be apparent to one skilled in the art that above-mentioned components of the printer 100 have been provided only for illustration purposes, without departing from the scope of the disclosure.

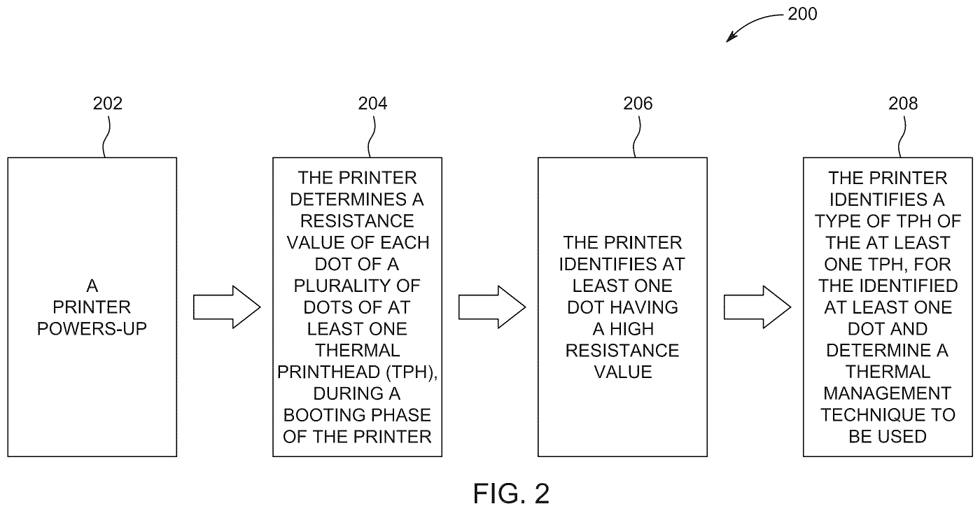

FIG. 2 illustrates a flowchart of a method 200 for identifying the at least one TPH 102, in accordance with an example embodiment of the present disclosure.

At operation 202, the printer 100 may be configured to power up upon receiving an activation command. Further, the activation command may be provided by one or more external devices (e.g., laptops, computers or other computing devices). Further, the printer 100 may be connected with a power source. Further, upon receiving the activation command, the power source may be configured to supply a predefined amount of power to the printer 100. Further, the printer 100 may comprise the at least one TPH 102 having the plurality of dots. For example, a printer 100 is connected with a power source and installed with a power button. Further, the power button may be pressed by a user to initiate activation of the printer 100. Further, the printer 100 comprises at least one TPH 102 having 800 dots.

At operation 204, the printer 100 may be configured to determine a resistance value of each resistance of each dot of the plurality of dots, during the booting phase of the printer 100. Further, the at least one TPH 102 may further comprise the plurality of heaters. Further, each of the plurality of dots may be associated with each of the plurality of heaters. In some embodiments, the plurality of heaters may be configured to generate heat to perform the printing operation on the thermally sensitive media. For example, the printer 100 may comprise a processor 104 and a non-transitory memory 106. Further, the processor 104 is configured to determine a resistance value of each 1000 dots.

At operation 206, the printer 100 may be configured to identify at least one dot having a high resistance value by comparing the resistance value associated with each dot of the plurality of dots with the predefined threshold resistance value. In some embodiments, the predefined threshold resistance value may correspond to identification data of the at least one TPH 102. For example, the processor 104 is configured to identify at least one dot (e.g., 1^{st} dot and/or 864^{th} dot) from the 1000 dots having a high resistance value (e.g., 1350 ohms). The at least one dot is identified by comparing the resistance value associated with each dot with a predefined threshold resistance value (e.g., 500 ohms). The at least one dot (e.g., 1^{st} dot and/or 864^{th} dot) may have high resistance values above a predefined high threshold resistance value (e.g., 500 ohms). Thus, the at least one dot (e.g., 1^{st} dot and/or 864^{th} dot) have a high resistance value compared to the other dots that have resistance values below this threshold.

At operation 208, the printer 100 may be configured to identify the type of the at least one TPH 102, based on the identified at least one dot. Further, the printer 100 may be configured to determine the thermal management technique based on the identified type of the at least one TPH 102. In some embodiments, by using the determined thermal management technique, the processor 104 may be configured to dynamically adjust the thermal output of the plurality of heaters. For example, the processor 104 is configured to determine type of the at least one TPH 102 and accordingly identify a thermal management technique of the identified type of the at least one TPH 102. Further, the processor 104 may be configured to dynamically adjust the thermal output of the plurality of heaters associated with the 1000 dots.

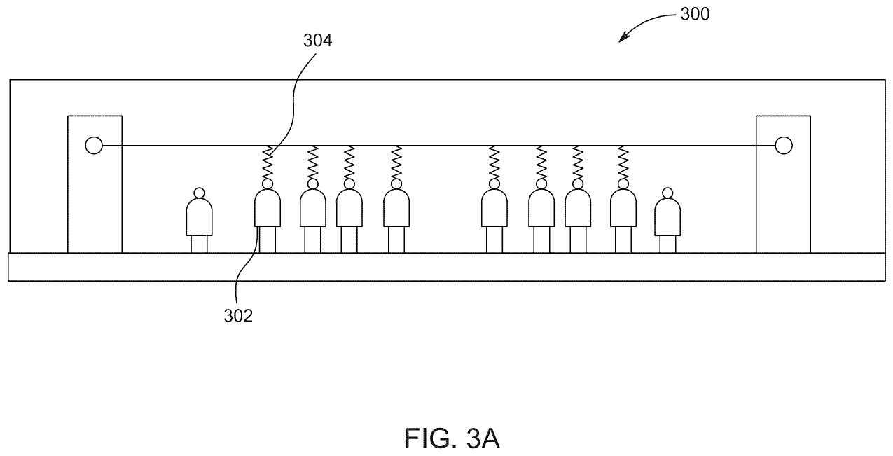

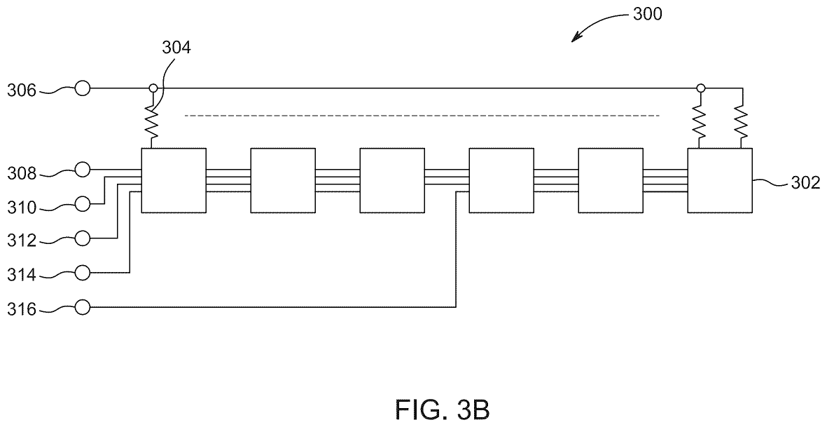

FIGS. 3A and 3B illustrate a schematic diagram of an integrated circuit (IC) 300 associated with the at least one TPH 102, in accordance with an example embodiment of the present disclosure.

In some embodiments, the printer 100 may further comprise the IC 300 for controlling activation of the plurality of heaters. Further, the IC 300 may also be referred to as a TPH driver IC. Further, the IC 300 may be fabricated with a plurality of shift registers 302. In some embodiments, the plurality of shift registers 302 may be connected with one or more pins of the IC 300 (as illustrated in FIG. 3B). Further, the one or more pins may include, but are not limited, to heating voltage 306, latch 308, clock 310, data in 312, strobe-1 314, and strobe-2 316.

In some embodiments, the plurality of shift registers 302 may be configured to receive data from the processor 104. Further, the data may comprise at least one of an image, a text, or a pattern to be printed. Further, the IC 300 may be configured to convert the data received by the plurality of shift registers 302 into one or more signals to selectively activate the plurality of heaters.

As illustrated in FIGS. 3A and 3B, the IC 300 further comprises a plurality of resistors 304 with different resistance values. Further, the plurality of resistors 304 may be associated with the plurality of heaters (the plurality of dots). In some embodiments, the plurality of resistors 304 may be configured to provide a predefined amount of power to the plurality of heaters. Further, the predefined amount of power may be adjusted by the processor, based on the determined thermal management technique. Further, upon receiving the one or more signals from the plurality of shift registers 302, the IC 300 may be configured to supply the predefined amount of power to selective resistors 304 from the plurality of resistors 304. Further, the plurality of resistors 304 further supplies power to heat the selective heaters from the plurality of heaters to perform the printing operation.

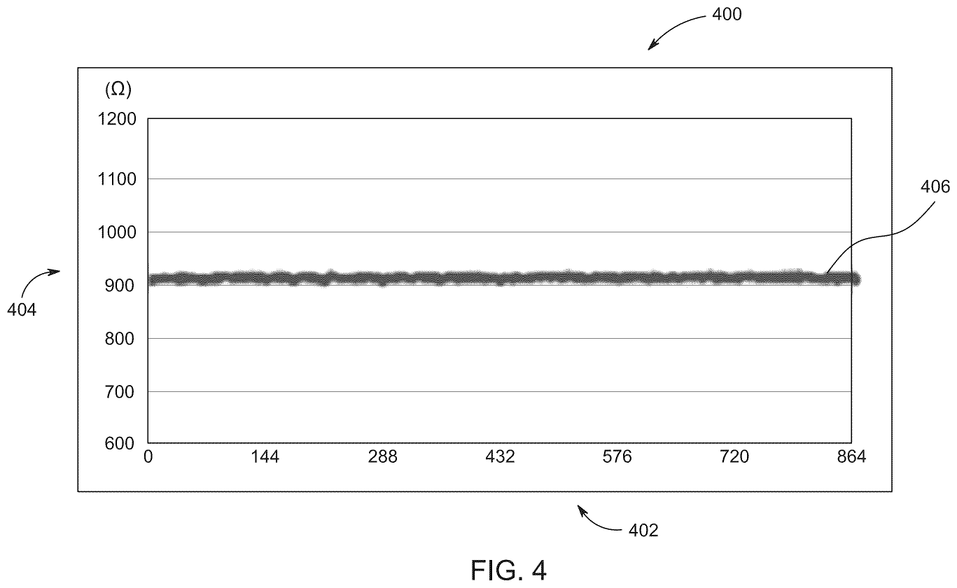

FIG. 4 illustrates a graph 400 associated with the predefined threshold resistance value of the plurality of dots, in accordance with an example embodiment of the present disclosure.

The graph 400 illustrates the resistances values associated with the plurality of dots of the at least one TPH 102. Further, the graph 400 comprises an X-axis 402 and a Y-axis 404. Further, the X-axis 402 may comprise the plurality of dots. Further, the plurality of dots ranges between 0-864 dots 406. Further, the Y-axis 404 comprise the resistance values associated with the plurality of dots. The resistance values may correspond to a range of 600 ohms to 1200 ohms. As illustrated in FIG. 4, the graph 400 provides an insight into the predefined threshold resistance value. Further, the predefined threshold resistance value may correspond to 900 ohms.

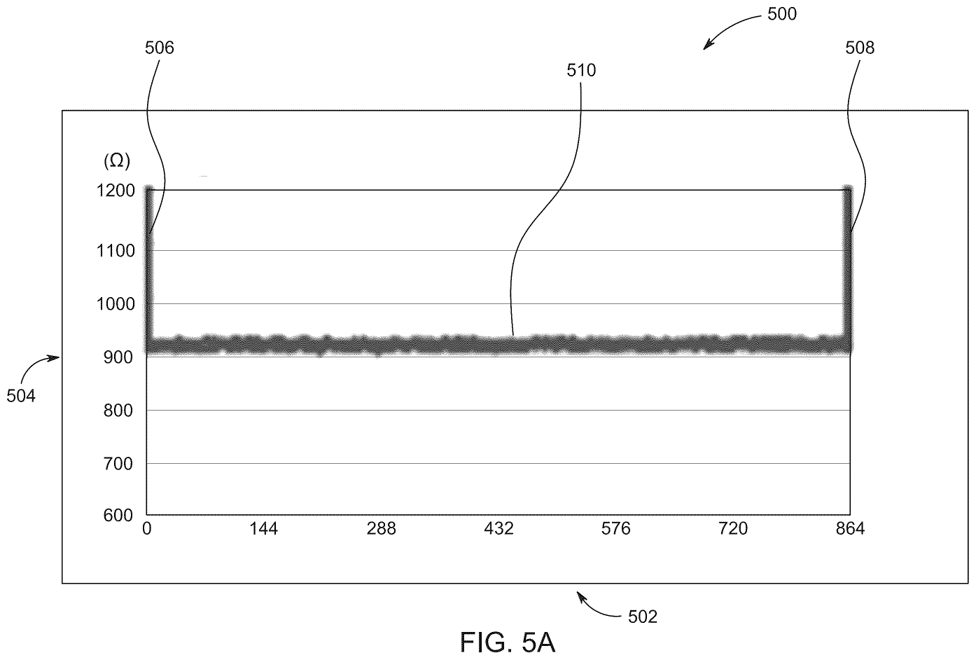

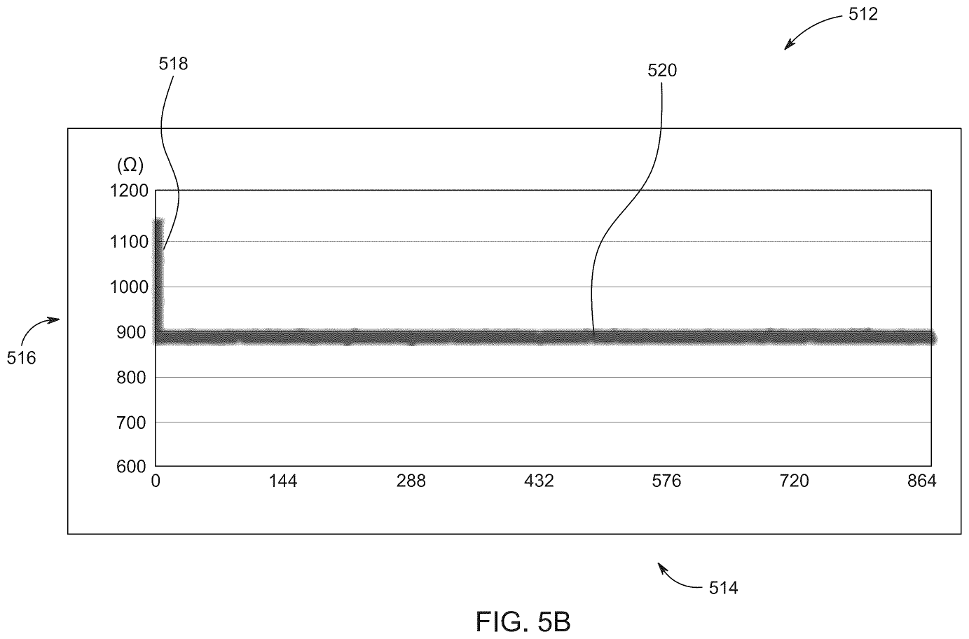

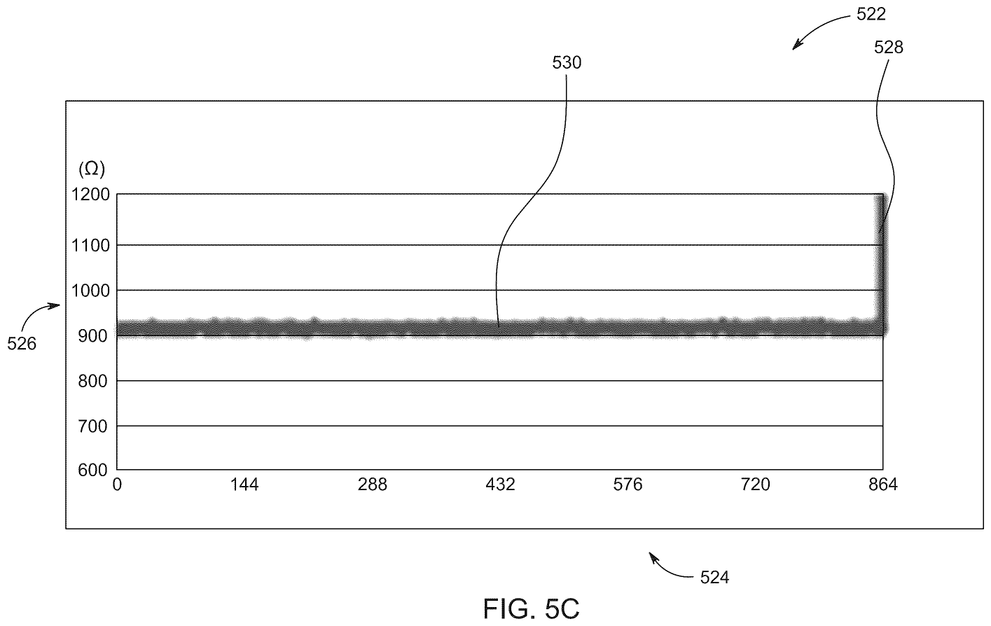

FIG. 5A illustrates a graph 500 associated with the resistance values associated with the plurality of dots of a first type of TPH of the at least one TPH, in accordance with an example embodiment of the present disclosure. FIG. 5B illustrates a graph 512 associated with the resistance values associated with the plurality of dots of a second type of TPH of the at least one TPH, in accordance with an example embodiment of the present disclosure. FIG. 5C illustrates a graph 522 associated with the resistance values associated with the plurality of dots of a third type of TPH of the at least one TPH, in accordance with an example embodiment of the present disclosure.

The graph 500 illustrates the resistances values associated with the plurality of dots of the at least one TPH 102. Further, the graph 500 comprises an X-axis 502 and a Y-axis 504. Further, the X-axis 502 may comprise the plurality of dots. Further, the plurality of dots ranges between 0-864 dots. Further, the plurality of dots from the ^{th} dot to the 864^{th} dot may be arranged in the first pattern. Further, the Y-axis 504 comprise the resistance values associated with the plurality of dots. The resistance values may correspond to a range of 600 ohms to 1200 ohms. As illustrated in FIG. 5A, the graph 500 depicts that a resistance value of the 0^{th} dot 506 is 1200 ohms. Further, the 0^{th} dot may be positioned at the first end of the first pattern of the plurality of dots. Further, a resistance value of the 864^{th} dot 508 is 1200 ohms. Further, the 864^{th} dot may be positioned at the second end of the first pattern of the plurality of dots. Further, the resistance value from the 1^{st} dot to the 863^{rd} dot 510 is 900 ohms. In at least one example, the processor 104 may be configured to identify a first type of the at least one TPH 102, based on the determined resistance value of the 0^{th} dot 506 and 864^{th} dot 508.

As illustrated in FIG. 5B, the graph 512 illustrates the resistances values associated with the plurality of dots of the at least one TPH 102. Further, the graph 512 comprises an X-axis 514 and a Y-axis 516. Further, the X-axis 514 may comprise the plurality of dots. Further, the plurality of dots ranges between 0-864 dots. Further, the plurality of dots from the 0^{th} dot to the 864^{th} dot may be arranged in the second pattern. Further, the Y-axis 516 comprise the resistance values associated with the plurality of dots. the resistance values may correspond to a range of 600 ohms to 1200 ohms. As illustrated in FIG. 5B, the graph 512 depicts that a resistance value of the 0^{th} dot 518 is 1200 ohms. Further, the 0^{th} dot may be positioned at the first end of the second pattern of the plurality of dots. Further, the resistance value from the 1^{st} dot to the 864^{th} dot 520 is 900 ohms. Further, the 864^{th} dot may be positioned at the second end of the second pattern of the plurality of dots. In another example, the processor 104 may be configured to identify a second type of TPH of the at least one TPH 102, based on the determined resistance value of the 0^{th} dot 520.

As illustrated in FIG. 5C, the graph 522 illustrates the resistances values associated with the plurality of dots of the at least one TPH 102. Further, the graph 522 comprises an X-axis 524 and a Y-axis 526. Further, the X-axis 524 may comprise the plurality of dots. Further, the plurality of dots ranges between 0-864 dots. Further, the plurality of dots from the 0^{th} dot to the 864^{th} dot may be arranged in the third pattern. Further, the 0^{th} dot may be positioned at the first end of the third pattern of the plurality of dots. Further, the Y-axis 526 comprise the resistance values associated with the plurality of dots. the resistance values may correspond to a range of 600 ohms to 1200 ohms. As illustrated in FIG. 5C, the graph 522 depicts that a resistance value of the 864^{th} dot 528 is 1200 ohms. Further, the 864^{th} dot may be positioned at the second end of the third pattern of the plurality of dots. Further, the resistance value from the 0^{th} dot to the 863^{rd} dot 530 is 900 ohms. In another example, the processor 104 may be configured to identify a third type of TPH of the at least one TPH 102, based on the determined resistance value of the 864^{th} dot 528.

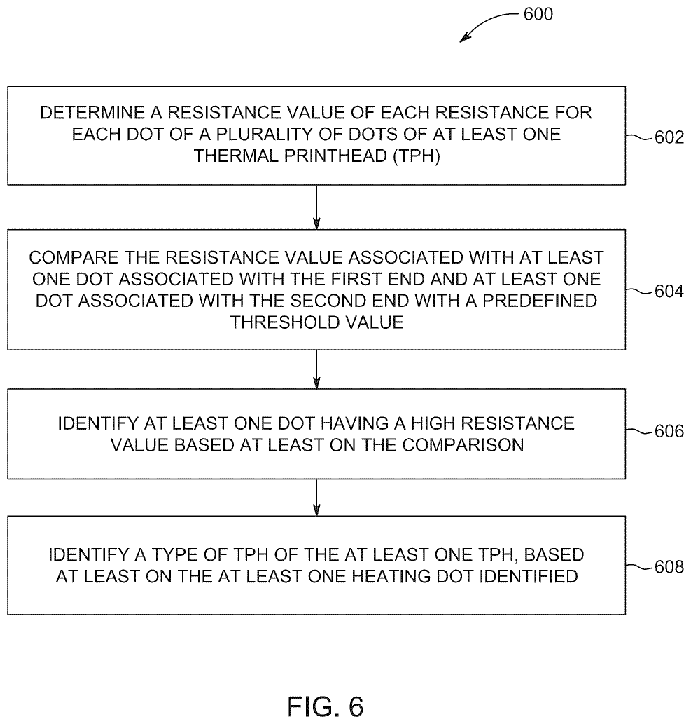

FIG. 6 illustrates a flowchart of a method 600 for identifying a type of the at least one TPH 102, in accordance with an example embodiment of the present disclosure.

At operation 602, the resistance value of each dot of the plurality of dots (e.g., as described at step 204) may be determined by the non-transitory memory 106 and the computer program code and the printer. Further, the non-transitory memory 106 and the computer program code with the processor 104 may cause the printer 100 to determine the resistance value, during a booting phase of the printer 100. Further, each of the plurality of dots may be associated with each of the plurality of heaters of the at least one TPH 102. For example, a printer 100 comprising at least one TPH 102 is connected with a power source. Further, the at least one TPH 102 having 500 dots each having different resistance values (e.g., 0-900 ohms). Further, a processor 104 and a non-transitory memory 106 is provided in the printer 100. Further, the printer 100 is configured to determine the resistance value of each dot of the 500 dots of the at least one TPH 102.

At operation 604, the resistance value associated with the at least one dot with the predefined threshold resistance value (as explained at step 206 of FIG. 2) may be compared by the non-transitory memory 106 and the printer. In some embodiments, the non-transitory memory 106 and the computer program code with the processor 104 may cause the printer 100 to compare the resistance value associated with the at least one dot with the predefined threshold resistance value. In some embodiments, the predefined threshold resistance value may correspond to identification data of the at least one TPH 102. In some embodiments, the predefined threshold resistance value may correspond to a resistance pattern of the plurality of heaters of the at least one TPH 102. For example, the printer 100 is configured to compare the resistance value associated with each dot of the 500 dots with a predefined threshold resistance value (e.g., 500 ohms) through the processor 104 and the non-transitory memory 106.

At operation 606, the at least one dot having a high resistance value may be identified by the non-transitory memory 106 and the printer 100 based at least on the comparison (e.g., as described at step 206). Further, the non-transitory memory 106 with the processor 104, cause the printer 100 to identify the at least one dot having the high resistance value. Further, the resistance values associated with each dot of plurality of dots may be configured to provide a pattern of resistance values. For example, the printer 100 is configured to identify at least one dot (e.g., 200th dot), from the 500 dots having a high resistance value (e.g., 650 ohms) through the processor 104 and the non-transitory memory 106.

At operation 608, the type of TPH of the at least one TPH may be identified by the non-transitory memory 106 and the printer 100, based at least on the at least one heating dot identified (e.g., as described at step 208). Further, the non-transitory memory 106 and the computer program code with the processor 104, cause the printer 100 to identify the type of TPH of the at least one TPH. Further, the type of the at least one TPH 102 may corresponds to different series and variants of the at least one TPH 102 installed within the printer 100. Further, the pattern of resistance values of each of the plurality of dots may be configured to define identification of the at least one TPH 102. For example, the processor 104 is configured to identify a first type of the at least one TPH 102. Further, the processor 104 accordingly identifies a thermal management technique of the identified type of the at least one TPH 102. Further, the processor 104 may be configured to dynamically adjust the thermal output of the plurality of heaters associated with the 500 dots.

Various embodiments of the present disclosure disclose the printer 100 to identify a type of the at least one TPH 102. The resistance values of each dot of the plurality of dots may be determined by the processor 104. The at least one dot of the plurality of dots having a high resistance value may be identified by the processor 104. The type of at least one TPH 102 may be identified by the processor 104 and according to the thermal management technique may be determined by the processor 104. The embodiments may enhance energy efficiency of the at least one TPH 102 by determining the thermal management technique. Further, a print quality of the printer 100 may be ensured by providing a proper thermal output by the plurality of heaters. embodiments may extend a lifespan of the at least one TPH 102 by preventing an excessive thermal stress on the plurality of dots of the at least one TPH 102.

Many modifications and other embodiments of the disclosure set forth herein will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A printer comprising:
at least one thermal printhead (TPH) comprising:
a plurality of dots, wherein each dot has an associated resistance, wherein the plurality of dots are arranged in a first pattern, and wherein the first pattern includes a first end and a second end; and
a processor and a non-transitory memory comprising a computer program code, the non-transitory memory and the computer program code configured to, with the processor, cause the printer to:
determine a resistance value for each dot of the plurality of dots;
compare the resistance value associated with at least one dot associated with the first end and at least one dot associated with the second end with a predefined threshold resistance value;
identify at least one dot having a high resistance value based at least on the comparison; and
identify a type of TPH of the at least one TPH based at least on the at least one dot identified.

2. The printer of claim 1, wherein the non-transitory memory and the computer program code are configured to, with the processor, cause the printer to determine a thermal management technique based at least on the type of TPH of the at least one TPH identified.

3. The printer of claim 2, wherein the at least one TPH further comprising a plurality of heaters, wherein each of the plurality of heaters is associated with one dot of the plurality of dots.

4. The printer of claim 3, wherein the non-transitory memory and the computer program code are configured to, with the processor, cause the printer to adjust a thermal output of the plurality of heaters based at least on the determined thermal management technique.

5. The printer of claim 1, wherein the plurality of dots correspond to a plurality of shift registers associated with the at least one TPH.

6. The printer of claim 1, wherein the predefined threshold resistance value associated with the plurality of dots is stored in the non-transitory memory.

7. The printer of claim 1, wherein the non-transitory memory and the computer program code are configured to, with the processor, cause the printer to read the resistance value of each of the plurality of dots during a booting phase of the printer.

8. The printer of claim 1, wherein the resistance value of each dot defines a range of TPH resistance specification—900 ohms+/−certain manufacturing tolerance—7%.

9. The printer of claim 1, wherein the plurality of dots define a range between 0-N dots.

10. The printer of claim 1, wherein the type of TPH of the at least one TPH identified is one of a plurality of TPH series.

11. The printer of claim 1, wherein the first pattern of the plurality of dots corresponds to a resistance pattern of the plurality of dots, wherein the resistance pattern defines the type of TPH of the at least one TPH.

12. A method comprising:
determining a resistance value for each dot of a plurality of dots of at least one thermal printhead (TPH), wherein the plurality of dots are arranged in a first pattern, and wherein the first pattern includes a first end and a second end;
comparing the resistance value associated with at least one dot associated with the first end and at least one dot associated with the second end with a predefined threshold resistance value;
identifying at least one dot having a high resistance value based at least on the comparison; and
identifying a type of TPH of the at least one TPH, based at least on the at least one dot identified.

13. The method of claim 12 further comprising determining a thermal management technique based at least on the type of TPH of the at least one TPH identified.

14. The method of claim 13, wherein the at least one TPH further comprises a plurality of heaters, wherein each of the plurality of heaters is associated with one dot of the plurality of dots.

15. The method of claim 14 further comprising adjusting a thermal output of the plurality of heaters, based at least on the determined thermal management technique.

16. The method of claim 12, wherein the plurality of dots corresponds to a plurality of shift registers associated with the at least one TPH.

17. The method of claim 12 further comprising storing the predefined threshold resistance value associated with the plurality of dots.

18. The method of claim 12 further comprising reading the resistance value of each of the plurality of dots during a booting phase of a printer.

19. The method of claim 12, wherein the resistance value of each dot defines a range of TPH resistance specification—900 ohms+/−certain manufacturing tolerance—7% and the plurality of dots defines a range between 0-N dots.

20. The method of claim 12, wherein the type of TPH of the at least one TPH identified one of a plurality of TPH series.
